(19) United States
(12) Patent Application Publication
(10) Pub. No.: US 2025/0200097 A1
(43) Pub. Date: Jun. 19, 2025

(54) INFORMATION PROCESSING SYSTEM, IMAGE PROCESSING APPARATUS, INFORMATION PROCESSING METHOD, AND NON-TRANSITORY RECORDING MEDIUM

(71) Applicant: Nobuya MONDEN, KANAGAWA (JP)

(72) Inventor: Nobuya MONDEN, KANAGAWA (JP)

(21) Appl. No.: 18/976,332

(22) Filed: Dec. 11, 2024

(30) Foreign Application Priority Data
Dec. 18, 2023 (JP) 2023-213335

(51) Int. Cl. G06F 16/34; G06F 16/583; G06F 40/109

(52) U.S. Cl. CPC G06F 16/345; G06F 16/5846; G06F 40/109

(57) ABSTRACT

An information processing system includes circuitry. The circuitry controls reading of image data from a document according to an instruction from a user. The circuitry acquires characteristic information of the user. The circuitry receives, from the user, information indicating conversion processing to be performed on text included in the image data. The circuitry extracts the text from the image data. The circuitry inputs, to a large language model, information including an instruction instructing that the conversion processing is to be performed on the text and that a result of the conversion processing is to be suitable for a person corresponding to the characteristic information. The circuitry acquires a conversion result that is output by the large language model. The circuitry outputs the conversion result.

### CROSS-REFERENCE TO RELATED APPLICATION

This patent application is based on and claims priority pursuant to 35 U.S.C. § 119 (a) to Japanese Patent Application No. 2023-213335, filed on Dec. 18, 2023, in the Japan Patent Office, the entire disclosure of which is hereby incorporated by reference herein.

### BACKGROUND

### Technical Field

The present disclosure relates to an information processing system, an image processing apparatus, an information processing method, and a non-transitory recording medium.

### Related Art

A technology has been proposed to apply a machine learning model to text extracted from image data by character recognition such as optical character recognition (OCR).

For example, a system has been proposed that corrects text obtained by OCR using a neural network trained based on erroneously OCR-recognized portion and text near the erroneously recognized portion.

### SUMMARY

The present disclosure described herein provides an information processing system including circuitry. The circuitry controls reading of image data from a document according to an instruction from a user. The circuitry acquires characteristic information of the user. The circuitry receives, from the user, information indicating conversion processing to be performed on text included in the image data. The circuitry extracts the text from the image data. The circuitry inputs, to a large language model, information including an instruction instructing that the conversion processing is to be performed on the text and that a result of the conversion processing is to be suitable for a person corresponding to the characteristic information. The circuitry acquires a conversion result that is output by the large language model. The circuitry outputs the conversion result.

The present disclosure described herein provides an image processing apparatus including circuitry. The circuitry controls reading of image data from a document according to an instruction from a user. The circuitry acquires characteristic information of the user. The circuitry receives, from the user, information indicating conversion processing to be performed on text included in the image data. The circuitry transmits the image data, the characteristic information, and information indicating the conversion processing to an information processing apparatus through a network. The circuitry receives, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information. The circuitry outputs the conversion result.

The present disclosure described herein provides an information processing method. The method includes controlling reading of image data from a document according to an instruction from a user. The method includes acquiring characteristic information of the user. The method includes receiving, from the user, information indicating conversion processing to be performed on text included in the image data. The method includes transmitting the image data, the characteristic information, and information indicating the conversion processing to an information processing apparatus through a network. The method includes receiving, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information. The method includes outputting the conversion result.

The present disclosure described herein provides a non-transitory recording medium storing a plurality of program codes which, when executed by one or more processors, causes the one or more processors to perform the above-described method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to the first embodiment;

FIG. 2 is a diagram illustrating a hardware configuration of an image processing apparatus according to the first embodiment;

FIG. 3 is a diagram illustrating a hardware configuration of an information processing apparatus according to the first embodiment;

FIG. 4 is a diagram illustrating a functional configuration of the information processing system according to the first embodiment;

FIG. 5 is a sequence diagram of an operation performed by the information processing system of FIG. 1;

FIG. 6 is a diagram illustrating a first example of a configuration of a user information storage unit;

FIG. 7 is a diagram illustrating a second example of a configuration of the user information storage unit;

FIG. 8 is a diagram illustrating an example of a template for a prompt;

FIG. 9 is a diagram illustrating a functional configuration of an information processing system according to the second embodiment;

FIG. 10 is a diagram illustrating a functional configuration of an information processing system according to the third embodiment; and

FIG. 11 is a diagram illustrating a functional configuration of an information processing system according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

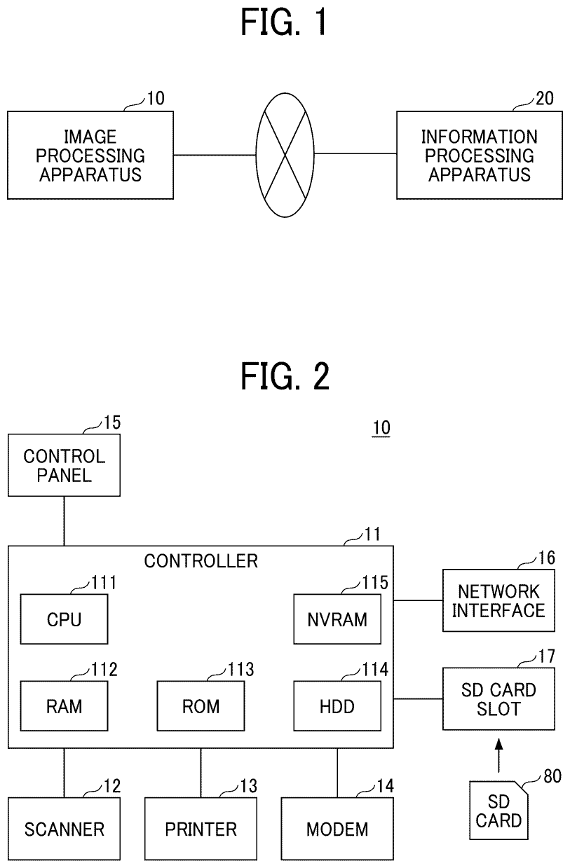

Embodiments of the present disclosure are described below with reference to the drawings. FIG. 1 is a diagram illustrating a configuration of an information processing system according to the first embodiment. In FIG. 1, the information processing system includes one or more image processing apparatuses 10 and an information processing apparatus 20. The image processing apparatus 10 is connected to the information processing apparatus 20 through a network such as a local area network (LAN) or the Internet.

The image processing apparatus 10 is a device having a function of reading (scanning) image data from a document (paper document), a communication function, and an information processing function. For example, the image processing apparatus 10 may be a device including a scanner and a printer, or a multifunction peripheral. The image processing apparatus 10 requests the information processing apparatus 20 to perform conversion processing such as translation or summarization instructed by a user on text included in image data that is read from a document. In the following description, such image data may be referred to as a “scanned image.” The image processing apparatus 10 receives the conversion result from the information processing apparatus 20 and outputs the conversion result.

The information processing apparatus 20 is one or more computers that perform the conversion processing requested by the image processing apparatus 10. The information processing apparatus 20 applies character recognition such as optical character recognition (OCR) to the scanned image to extract text (a character string) from the scanned image, and performs the conversion processing on the text. The information processing apparatus 20 uses a large language model (LLM) specialized for natural language processing among neural networks as a generative artificial intelligence (AI) in the conversion processing. A large language model is a trained model used for natural language processing (NLP). A large language model can learn a large amount of text data and implement natural, human-like language generation and understanding. A large language model has a more advanced understanding of natural language than conventional natural language processing models, and has demonstrated superior results in natural language processing tasks such as generating natural sentences and answering questions. Examples of such an LLM include GPT-3 and GPT-4 developed by OpenAI, Inc., and BERT developed by GOOGLE.

When using such a large language model, the information processing apparatus 20 causes the large language model to perform conversion processing to obtain a conversion result suitable for a user of the image processing apparatus 10. The term “conversion” refers to changing (altering) a part or all of text to a set of different text. Examples of the conversion include summarization and translation.

The information processing system is used in any environment. In the present embodiment, for the sake of explanatory convenience, a case in which the information processing system is used in a company is described.

FIG. 2 is a block diagram illustrating a hardware configuration of the image processing apparatus 10 according to the first embodiment. In FIG. 2, the image processing apparatus 10 includes hardware elements such as a controller 11, a scanner 12, a printer 13, a modem 14, a control panel 15, a network interface 16, and a secure digital (SD) card slot 17.

The controller 11 includes a central processing unit (CPU) 111, a random-access memory (RAM) 112, a read-only memory (ROM) 113, a hard disk drive (HDD) 114, and a non-volatile random-access memory (NVRAM) 115. The ROM 113 stores various programs and data used by the programs. The RAM 112 is used as a memory area to which a program is loaded and used as a work area for executing a loaded program. The CPU 111 executes the program loaded to the RAM 112 to implement various functions. The HDD 114 stores programs and various data used by the programs. The NVRAM 115 stores various setting information.

The scanner 12 is hardware (image reading means) that scans a document to obtain image data. The printer 13 is hardware (printing means) that forms an image on a sheet in accordance with print data. The modem 14 is hardware for connecting to a telephone line and is used for transmitting and receiving image data by facsimile communication. The control panel 15 is hardware that includes an input device such as keys or buttons that accepts a user input and a display device such as a liquid crystal panel. The liquid crystal panel may have a touch panel function. In this case, the liquid crystal panel also implements a function of the input device. The network interface 16 is hardware to connect the image processing apparatus 10 to a wired or wireless network, such as a LAN. The SD card slot 17 is used for reading programs stored in an SD card 80. Accordingly, in the image processing apparatus 10, not only the programs stored in the ROM 113 but also the programs stored in the SD card 80 may be loaded to the RAM 112 for execution. In addition or in alternative to the SD card 80, any other suitable storage medium may be used, such as a compact disc-read-only memory (CD-ROM) or a universal serial bus (USB) memory. In other words, the type of storage medium corresponding to the SD card 80 is not limited to a specific type. In this case, any other suitable hardware is used in alternative to the SD card slot 17 depending on a type of storage medium.

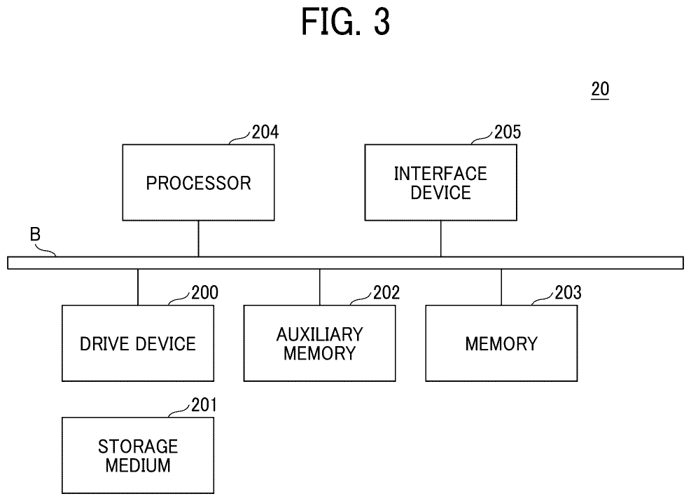

FIG. 3 is a block diagram illustrating a hardware configuration of the information processing apparatus 20 according to the first embodiment. The information processing apparatus 20 of FIG. 3 includes a drive device 200, an auxiliary memory 202, a memory 203, a processor 204, and an interface device 205 that are connected to each other through a bus B.

A program that implements processing of the information processing apparatus 20 is provided by a storage medium 201 such as a CD-ROM. When the storage medium 201 storing the program is set in the drive device 200, the program is installed in the auxiliary memory 202 from the storage medium 201 via the drive device 200. Alternatively, the program may be downloaded from another computer through a network, instead of installed from the storage medium 201. The auxiliary memory 202 stores the installed program and also stores files and data to be used.

In response to an instruction to activate the program, the memory 203 reads the program from the auxiliary memory 202 and stores the program. The processor 204 is a CPU alone or a graphics processing unit (GPU) alone, or both of a CPU and a GPU, and executes functions relating to the information processing apparatus 20 according to the program stored in the memory 203. The interface device 205 is used for connecting the information processing apparatus 20 to a network.

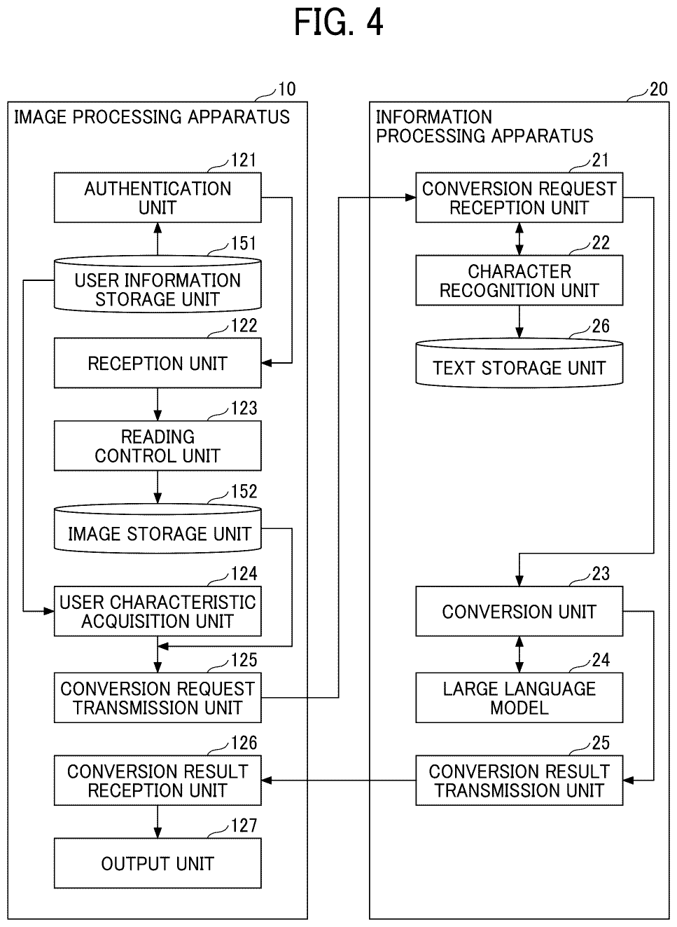

FIG. 4 is a diagram illustrating a functional configuration of the information processing system according to the first embodiment. In FIG. 4, the image processing apparatus 10 includes an authentication unit 121, a reception unit 122, a reading control unit 123, a user characteristic acquisition unit 124, a conversion request transmission unit 125, a conversion result reception unit 126, and an output unit 127. Each of these functional units is implemented by processes executed by the CPU 111 according to one or more programs installed on the image processing apparatus 10. The image processing apparatus 10 also uses a user information storage unit 151 and an image storage unit 152. Each of these storage units is implemented by, for example, the HDD 114 or a storage device connectable to the image processing apparatus 10 through a network.

The authentication unit 121 authenticates a user who uses the image processing apparatus 10. The user information storage unit 151 is referred to for authentication purpose. The user information storage unit 151 stores information to be used for the authentication of a user who is permitted to use the image processing apparatus 10 and attribute information of the user.

The reception unit 122 receives an instruction from a user. For example, the reception unit 122, from the user, an instruction relating to reading (scanning) image data from a document and information indicating conversion processing to be performed on text (character string) included in the image (scanned image).

The reading control unit 123 controls reading of image data from a document according to the instruction from the user. The reading control unit 123 stores the image data in the image storage unit 152.

The user characteristic acquisition unit 124 acquires characteristic information of a user of the image processing apparatus 10. In the following description, such characteristic information of the user may be referred to “user characteristic information.” The user characteristic information is information indicating a characteristic of a user.

The characteristic of a user refers to a user's characteristic that may affect understanding of text. Examples of information relating to the characteristic of a user include a department to which the user belongs, a language used by the user, and an age (age group) of the user.

However, what is defined as the characteristic of a user may be selected as appropriate depending on how the information processing system is to be operated.

The conversion request transmission unit 125 transmits a conversion request including the scanned image, the user characteristic information, and the information indicating the conversion processing to the information processing apparatus 20 through a network.

The conversion result reception unit 126 receives a result of the conversion processing (conversion result) on the text included in the scanned image from the information processing apparatus 20.

The output unit 127 outputs the conversion result received by the conversion result reception unit 126.

The information processing apparatus 20 includes a conversion request reception unit 21, a character recognition unit 22, a conversion unit 23, a large language model 24, and a conversion result transmission unit 25. Each of the above-mentioned functional units is implemented by the processor 204 executing one or more programs installed on the information processing apparatus 20. The information processing apparatus 20 also uses a text storage unit 26. The text storage unit 26 is implemented by, for example, the auxiliary memory 202 or a storage device that is connectable to the information processing apparatus 20 through a network.

The conversion request reception unit 21 receives the conversion request transmitted from the conversion request transmission unit 125. In other words, the conversion request reception unit 21 receives, from the image processing apparatus 10, the image data (scanned image) read from a document by the image processing apparatus 10 in response to a user instruction, the user characteristic information, and the information indicating conversion processing to be performed on text included in the image data.

The character recognition unit 22 extracts text from the image data (scanned image) corresponding to the conversion request.

The character recognition unit 22 extracts a character string indicating the text, for example, by applying character recognition such as an OCR to the scanned image. The character recognition unit 22 stores the extracted text in the text storage unit 26. The character recognition unit 22 may be implemented by an external information processing apparatus (e.g., an OCR server having dictionary data) different from the information processing apparatus 20.

The conversion unit 23 inputs information (prompt) including an instruction that the conversion processing corresponding to the conversion request is to be performed on the text extracted by the character recognition unit 22 and that the result of the conversion processing is suitable for a person corresponding to the user characteristic information corresponding to the conversion request to the large language model 24. Further, the conversion unit 23 acquires text as the conversion result output by the large language model 24. In the present disclosure, “suitable for a person corresponding to the user characteristic information” refers to that the result of the conversion processing is easy to understand (easy to read) for the person corresponding to the user characteristic information. For example, the text is summarized, translated, or converted according to the user's age group or language, or the department to which the user belongs.

The large language model 24 is a large language model as described above. For example, ChatGPT may be used as the large language model 24. The large language model 24 does not have to be included in the information processing apparatus 20. For example, the large language model 24 may be called from the information processing apparatus 20 through a network.

The conversion result transmission unit 25 transmits the conversion result acquired by the conversion unit 23 to the image processing apparatus 10.

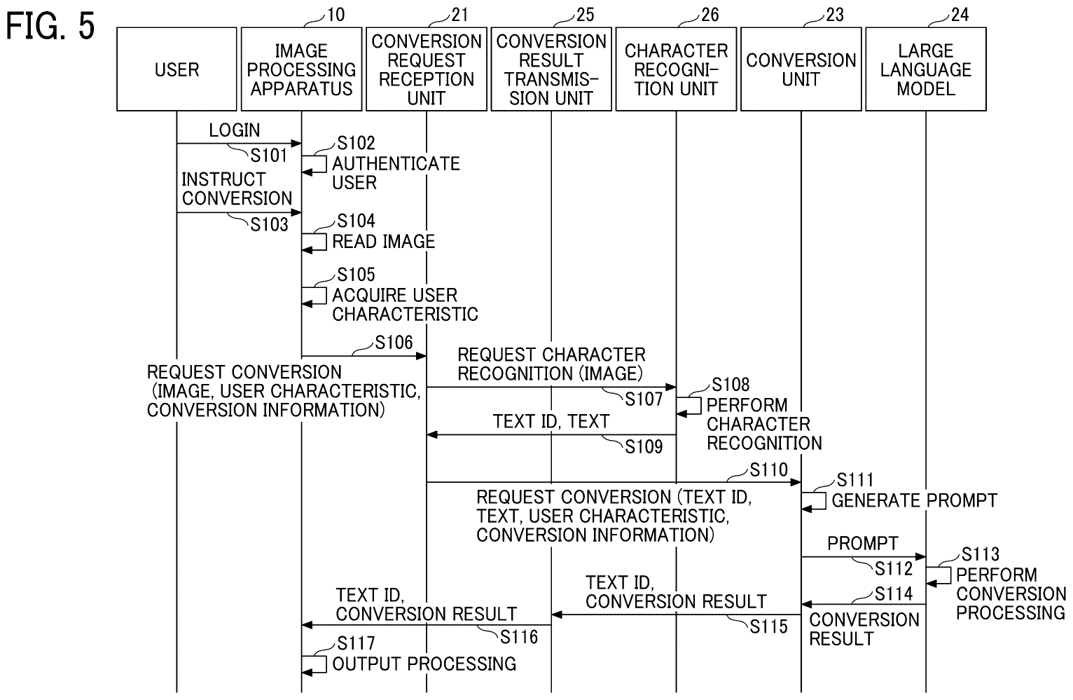

An operation performed by the information processing system is described below. FIG. 5 is a sequence diagram of an operation performed by the information processing system.

In step S101, the authentication unit 121 of the image processing apparatus 10 receives a login operation from a user via a login screen displayed on the control panel 15. By the login operation, information to be used for user authentication, such as a user identifier (ID) and a password, is input as login information. Information used in other known authentication method, such as biometric information, may be input as the login information.

In step S102, the authentication unit 121 collates the input login information with information stored in the user information storage unit 151 for user authentication.

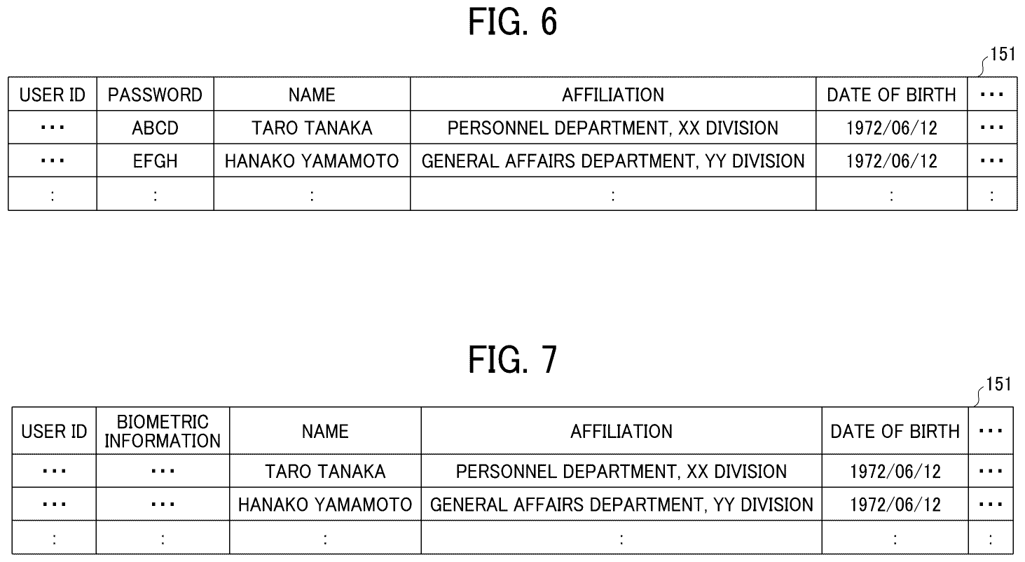

FIG. 6 is a diagram illustrating a first example of the configuration of the user information storage unit 151. As illustrated in FIG. 6, the user information storage unit 151 stores a user ID, a password, a name, an affiliation, a date of birth, etc., for each user who is permitted to use the image processing apparatus 10.

The user ID is identification information of the user. The password is a valid password registered for the user associated with the user ID. The name is the name of the user associated with the user ID. The affiliation is information (e.g., a department name) indicating an organization or entity to which the user associated with the user ID belongs. The date of birth is the user's date of birth. The age of the user can be identified based on the date of birth and the current date and time.

When a record including a set of a user ID and a password that match the input login information is stored in the user information storage unit 151, the authentication unit 121 determines that the authentication is successful, and identifies a user associated with the user ID of the login information as a login user.

FIG. 7 is a diagram illustrating a second example of the configuration of the user information storage unit 151. The user information storage unit 151 illustrated in FIG. 7 is different from that in FIG. 6 in that the user information storage unit 151 stores biometric information instead of the password for each user who is permitted to use the image processing apparatus 10. The biometric information is, for example, data indicating a facial characteristic (e.g., characteristic points such as positions of eyes, mouth, and nose) extracted from image data of the user's face. Other biometric information such as fingerprints or veins may be used. In this case, the authentication unit 121 may acquire the corresponding biometric information as the login information in step S101. When a record including biometric information that matches the acquired login information is stored in the user information storage unit 151, the authentication unit 121 determines that the authentication is successful, and identifies a user associated with the user ID of the login information as a login user.

When the authentication is successful, the authentication unit 121 records the content of the record including the user ID in the user information storage unit 151 in the RAM 112 as login user information, and erases the login screen. As a result, a home screen is displayed on the control panel 15. The home screen is a screen for receiving an instruction to perform various processing from the user. When the user information storage unit 151 does not store a record including a set of the user ID and the password or the biometric information that match the input login information, the authentication unit 121 determines that the authentication has failed. In this case, the processes of step S103 and subsequent steps are not performed.

In the present embodiment, the authentication is performed to acquire the user characteristic information.

For this reason, the authentication does not necessarily have to be performed, as long as the user characteristic information can be acquired.

In step S103, the reception unit 122 receives a conversion instruction from the user via the home screen. In the conversion instruction, for example, settings relating to reading of image data from a document, information indicating a desired conversion processing to be performed on text included in the image data are input. In the following description, the settings relating to reading of image data from a document may be referred to as “scan settings.” In the following description, the information indicating a desired conversion processing to be performed on text included in the image data may be referred to as “conversion information.” In consideration of reducing the operational burden on the user, the conversion processing may be selectable from multiple predetermined candidates (e.g., “summarization,” or “translation”). In this case, a character string (e.g., “summarization,” or “translation”) indicating the selected conversion processing is the conversion information. Alternatively, the conversion information may be input in a natural language. For example, “Please translate into English,” or “Please summarize within 400 characters” may be input as the conversion information.

In step S104, the reading control unit 123 controls the scanner 12 according to the scan settings that are input in the conversion instruction to control acquire a scanned image from a document. The reading control unit 123 stores the scanned image in the image storage unit 152, and generates identification information such as a uniform resource locator (URL) indicating a storage location of the scanned image. In the following description, such generated identification information may be referred to as an “image ID.”

In step S105, the user characteristic acquisition unit 124 acquires user characteristic information of the login user. For example, the user characteristic acquisition unit 124 may acquire the affiliation and the date of birth as information relating to the user characteristic information from among the login user information stored in the RAM 112. In this step, the user characteristic acquisition unit 124 may convert the date of birth into an age or an age group based on the current date and time. In a case that the large language model 24 has already learned the preference for text for each user (each name), a name may also be included in the user characteristic information. The user characteristic acquisition unit 124 may acquire a language setting for the control panel 15 as a part of the user characteristic information. The language setting for the control panel 15 refers to a setting regarding which language is to be used as a display language for the control panel 15. A user is likely to select a language that is easy for the user to understand. In other words, the language setting is information indicating a language that the user is likely to understand. In the present embodiment, the control panel 15 functions as a user interface of the information processing system. Accordingly, the language setting for the control panel 15 is an example of setting information regarding a display language of the information processing system. When the image processing apparatus 10 includes a camera, the user characteristic acquisition unit 124 may acquire a part of the user characteristic information further from image data indicating a user (image data including the user as a subject) that is imaged or input by the camera. For example, the user characteristic acquisition unit 124 may acquire a user's characteristic such as an age or a race from the image data acquired from the camera using a model that has learned the relation between image data and the user's characteristic such as an age.

In step S106, the conversion request transmission unit 125 transmits a conversion request including the scanned image, the user characteristic information acquired by the user characteristic acquisition unit 124, and the conversion information to the information processing apparatus 20.

In step S107, when the conversion request reception unit 21 of the information processing apparatus 20 receives the conversion request, the conversion request reception unit 21 requests the character recognition unit 22 to perform character recognition on the scanned image included in the conversion request.

In step S108, the character recognition unit 22 applies character recognition to the scanned image to extract a character string as text from the scanned image, and stores the text in the text storage unit 26. In the following description, such extracted and stored text may be referred to as “target text.” The character recognition unit 22 generates identification information such as a URL indicating a storage location of the target text. In the following description, such identification information may be referred to as an “target text ID.” In step S109, Subsequently, the character recognition unit 22 transmits the target text ID and the target text to the conversion request reception unit 21.

In step S110, the conversion request reception unit 21 transmits a conversion request including the target text ID, the target text, the user characteristic information, and the conversion information to the conversion unit 23.

In step S111, the conversion unit 23 generates a prompt for the large language model 24 based on the conversion request. The prompt is text information indicating an instruction to the large language model 24. The conversion unit 23 generates the prompt including an instruction to perform the conversion processing corresponding to the conversion information on the target text and an instruction that the result of the conversion processing is suitable for a person relating to the user characteristic information corresponding to the conversion request. For example, a template of the prompt may be preliminarily prepared. In this case, the conversion unit 23 may generate a prompt by applying the target text, the user characteristic information, and the conversion information to the template.

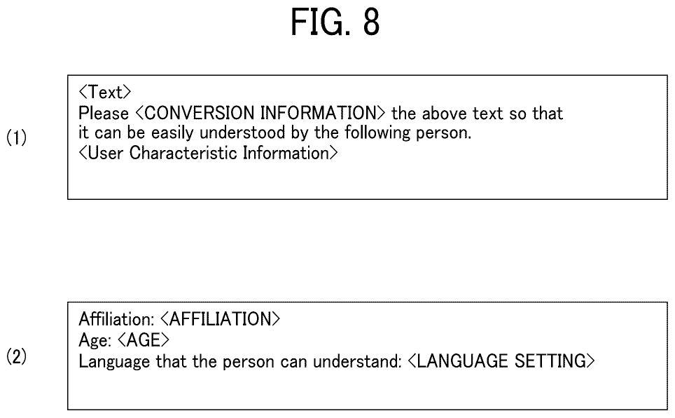

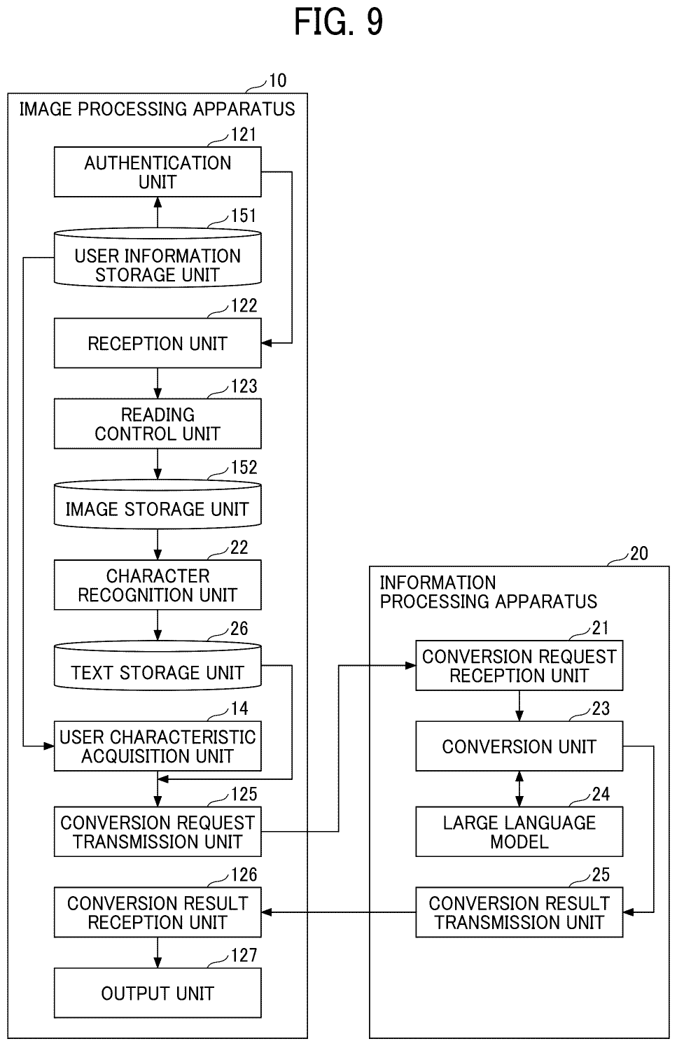

FIG. 8 is a diagram illustrating an example of the template for a prompt. In FIG. 8, (1) illustrates a template for the entirety of the prompt. Parts other than parts enclosed in < >are a template. <Text> is a part to be replaced by the target text on which conversion is to be performed. <Conversion Information> is a portion to be replaced by the conversion information. <User Characteristic Information> is a part to be replaced by the user characteristic information.

(2) of FIG. 8 is an example of a template for user characteristic information. In other words, the conversion unit 23 may apply a result obtained by replacing <AFFILIATION>, <AGE>, and <LANGUAGE SETTING> in (2) with the affiliation, the age, and the language setting (e.g., the language setting for the control panel 15) based on the user characteristic information to the <User Characteristic Information> in (1). By including the affiliation in the user characteristic information, the likelihood of obtaining a conversion result that refrains from using technical terms in a department different from the department to which the user belongs increases. Further, by including the language setting in the user characteristic information, when translation is performed, it is expected that translation into a language that the user can understand is performed even when the target language is not designated. By including the language setting in the user characteristic information, when summarization is performed, it is expected that the summary is automatically translated into the language that the user can understand.

In step S113, the conversion unit 23 inputs the prompt to the large language model 24 to cause the large language model 24 to perform the conversion processing (i.e., the conversion processing indicated by the conversion information) on the target text so that a conversion result suitable for the person corresponding to the user characteristic information is obtained. In step S114, the conversion unit 23 acquires output information from the large language model 24 as a conversion result for the target text. In step S115, the conversion unit 23 transmits the target text ID and the conversion result to the conversion result transmission unit 25. In step S116, the conversion result transmission unit 25 transmits the target text ID and the conversion result to the image processing apparatus 10.

In step S117, when the conversion result reception unit 126 of the image processing apparatus 10 receives the target text ID and the conversion result, the output unit 127 performs output processing on the conversion result. The conversion result is output in any suitable form. The output unit 127 may cause the image processing apparatus 10 to print the conversion result. The output unit 127 may display the conversion result on the control panel 15. The output unit 127 may store the conversion result in a storage device. The output unit 127 may convert the conversion result into a portable document format (PDF) file and transmit the PDF file through a network.

The output unit 127 may convert information indicating the storage location of the scanned image or the target text, such as the image ID of the scanned image or the target text ID, into a two-dimensional code and output the two-dimensional code together with the conversion result. For example, when the conversion result is printed, the output unit 127 may control the image processing apparatus 10 so that the two-dimensional code is printed on a printing sheet together with the conversion result. When the conversion result is converted into a PDF file, the output unit 127 may combine the two-dimensional code with the conversion result. By accessing the scanned image and the target text using the two-dimensional code, the user can easily check the content on which the conversion processing has not been performed yet regarding the conversion result.

The output unit 127 may identify a word that appears more frequently than other words in the text such as a summary or a translation result, which is the conversion result, and may apply text styling (e.g., changing color or font) to the identified word. For example, the output unit 127 may count words by descending frequency in the text and identify words in the top few percent or words appearing more than a predetermined number of times. This allows the user to easily identify a part that is a point in the conversion result.

The image processing apparatus 10 may receive an input of evaluation for the conversion result from a user who has referred to the conversion result. For example, the user may input a conversion result that the user expected. In this case, the image processing apparatus 10 transmits the conversion result that the user expected to the information processing apparatus 20. The information processing apparatus 20 may further train the large language model 24 using such a conversion result.

The description given above is of an example in which the number of large language model 24 is one. Alternatively, multiple large language models 24 that have learned technical terms unique to respective departments may be prepared for different departments (affiliations). In this case, in step S112, the conversion unit 23 may input the prompt to one of the large language models 24 corresponding to the affiliation included in the user characteristic information.

As described above, according to the first embodiment, conversion processing (altering) instructed by a user is performed on text included in image data that is read from a document. The conversion processing is performed taking into account the characteristic of the user. As a result, the likelihood of obtaining a conversion result suitable for each user increases. This assists in the task of understanding the text included in the image data that is read from the document.

For example, by performing summarization using words that are easy for a user to understand, the user can understand the content of text included in a document (e.g., minutes) without reading the entire text.

Further, by performing translation into a language suitable for a user, the user can understand the content of a document more accurately and quickly.

The second embodiment is described below. In the second embodiment, elements, members, components, or operations that are different from those of the first embodiment are described. In other words, elements, members, components, or operations of which description are omitted below may be the same or substantially the same as those of the first embodiment.

FIG. 9 is a diagram illustrating a functional configuration of the information processing system according to the second embodiment. In the description given with reference to FIG. 9, like reference signs are allocated to the same elements, members, components, or operations as those described with reference to FIG. 4, and the descriptions thereof are omitted as appropriate.

According to the configuration illustrated in FIG. 9, the image processing apparatus 10 includes the character recognition unit 22 and the text storage unit 26. In this case, for example, after the process of step S104 is performed and before the process of step S106 are performed, the same process as that of step S108 is performed by the image processing apparatus 10, and text is extracted from a scanned image. The conversion request transmitted in step S106 includes the text instead of the scanned image. In response to receiving the conversion request, the information processing apparatus 20 does not perform the processes of steps S107 to S109, but performs the processes of step S110 and the subsequent steps.

As described above, the character recognition processing may be performed internally by the image processing apparatus 10 or externally to the image processing apparatus 10.

The third embodiment is described below. In the third embodiment, elements, members, components, or operations that are different from those of the first embodiment are described. In other words, elements, members, components, or operations of which description are omitted below may be the same or substantially the same as those of the first embodiment.

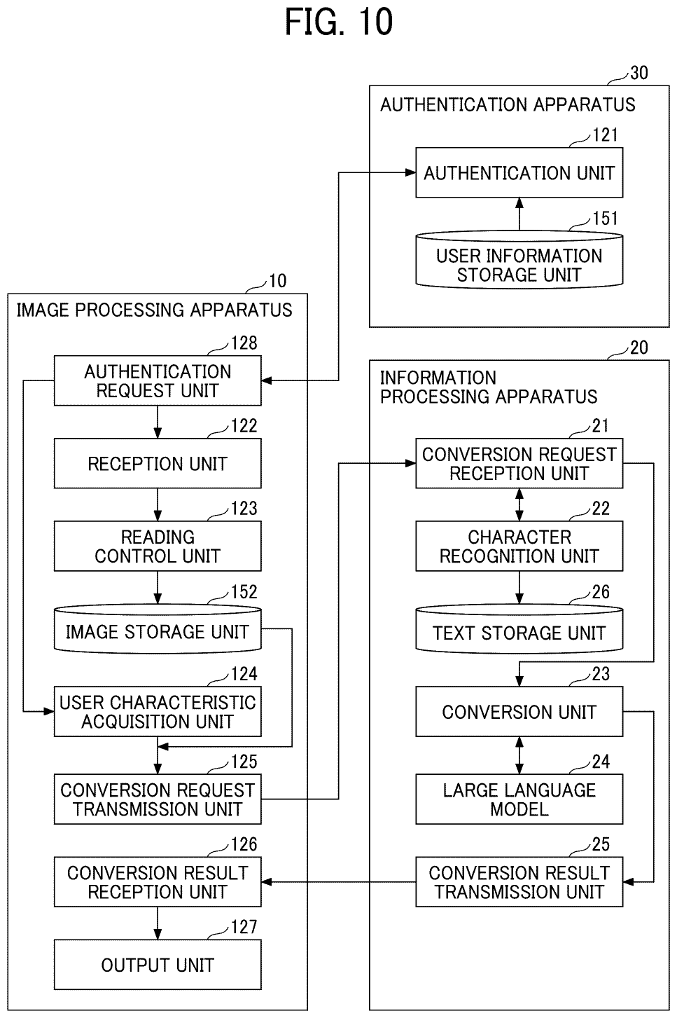

FIG. 10 is a diagram illustrating a functional configuration of the information processing system according to the third embodiment.

In the description given with reference to FIG. 10, like reference signs are allocated to the same elements, members, components, or operations as those described with reference to FIG. 4, and the descriptions thereof are omitted as appropriate.

As illustrated in FIG. 10, the information processing system further includes an authentication apparatus 30. The authentication apparatus 30 is connected to the image processing apparatus 10 through a network such as a LAN or the Internet. The authentication apparatus 30 includes the authentication unit 121 and the user information storage unit 151 included in the image processing apparatus 10 described with reference to FIG. 4.

The image processing apparatus 10 includes an authentication request unit 128. The authentication request unit 128 receives an input of the login information in step S101 of FIG. 5, and transmits the login information to the authentication apparatus 30. The authentication unit 121 of the authentication apparatus 30 performs authentication processing in the same or substantially the same manner as in step S102 of FIG. 5. When the authentication is successful, the authentication unit 121 transmits, for example, information stored in the user information storage unit 151 in association with the login user to the authentication request unit 128.

The processes other than the process described above are performed in the same or substantially the same manner as the first embodiment. The third embodiment may be combined with the second embodiment.

The fourth embodiment is described below. In the fourth embodiment, elements, members, components, or operations that are different from those of the first embodiment are described. In other words, elements, members, components, or operations of which description are omitted below may be the same or substantially the same as those of the first embodiment.

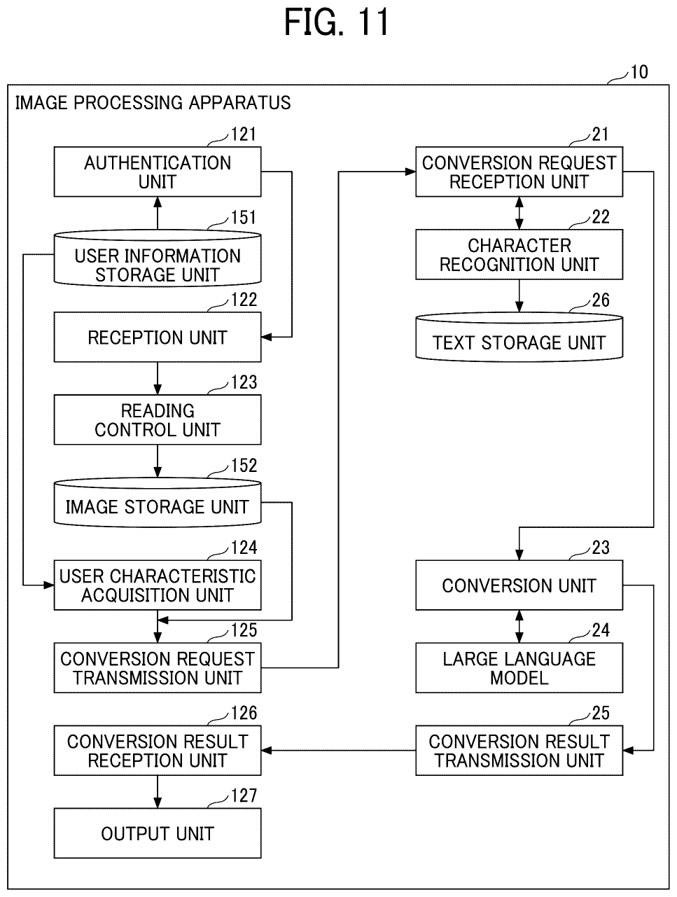

FIG. 11 is a diagram illustrating a functional configuration of the information processing system according to the fourth embodiment.

In the description given with reference to FIG. 11, like reference signs are allocated to the same elements, members, components, or operations as those described with reference to FIG. 4, and the descriptions thereof are omitted as appropriate.

As illustrated in FIG. 11, the image processing apparatus 10 has all the functions of the information processing apparatus 20 described with reference to FIG. 4. In other words, the image processing apparatus 10 alone constitutes the information processing system. Accordingly, in the fourth embodiment, all the processes of the steps in FIG. 5 are performed by the image processing apparatus 10.

The functionality of the elements of the above-described embodiments may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The apparatuses or devices described in the embodiments described above are merely one example of multiple computing environments that implement one or more embodiments of the disclosure.

In some embodiments, the information processing apparatus 20 includes multiple computing devices, such as a server cluster. The multiple computing devices communicate with one another through any type of communication link including, for example, a network and a shared memory, and perform the processes disclosed in the present disclosure. In substantially the same manner, the image processing apparatus 10 may include such multiple computing devices configured to communicate with one another.

Text (sentence) that is easy to understand may differ depending a user. For example, when the text is written in the same Japanese language, a sentence with fewer kanji characters is likely to be easier to understand for a person whose native language is not Japanese. In a company, familiar expressions vary depending on a department to which one belongs. For example, a user belonging to a legal department is familiar with a sentence such as “Party A is . . . to Party B.” However, a user belonging to a department other than the legal department has difficulty understanding such a sentence.

According to one or more embodiment of the present disclosure, a task of understanding text included in image data that is read from a document is assisted.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are, for example, as follows.

### Aspect 1

According to Aspect 1, an information processing system includes a reading control unit to control reading of image data from a document according to an instruction from a user.

The information processing system includes a user characteristic acquisition unit to acquire characteristic information of the user.

The information processing system includes a reception unit to receive, from the user, information indicating conversion processing to be performed on text included in the image data.

The information processing system includes a character recognition unit to extract the text from the image data.

The information processing system includes a conversion unit to input information including an instruction instructing that the conversion processing is to be performed on the text and that a result of the conversion processing is to be suitable for a person corresponding to the characteristic information to a large language model and acquire a conversion result that is output by the large language model.

The information processing system includes an output unit to output the conversion result.

### Aspect 2

According to Aspect 2, in the information processing system of Aspect 1, the conversion processing is summarization of the text or translation of the text.

### Aspect 3

According to Aspect 3, in the information processing system of Aspect 1 or 2, the user characteristic acquisition unit acquires setting information relating to a display language of the information processing system as a part of the characteristic information.

### Aspect 4

According to Aspect 4, in the information processing system of any one of Aspects 1 to 3, the output unit outputs, with the conversion result, information indicating a storage location where the image data or the text extracted from the image data is stored.

### Aspect 5

According to Aspect 5, in the information processing system of any one of Aspects 1 to 4, wherein the output unit applies text styling to a word that appears relatively frequently in text indicated by the conversion result.

### Aspect 6

According to Aspect 6, in the information processing system of any one of Aspects 1 to 5, the characteristic information includes information indicating an organization to which the user belongs.

### Aspect 7

According to Aspect 7, in the information processing system of any one of Aspects 1 to 6, the user characteristic acquisition unit acquires a part of the characteristic information from image data including the user as a subject.

### Aspect 8

According to Aspect 8, in the information processing system of Aspect 1, wherein the reception unit further receives an evaluation by the user for the conversion result.

### Aspect 9

According to Aspect 9, an image processing apparatus includes a reading control unit to control reading of image data from a document according to an instruction from a user.

The image processing apparatus includes a user characteristic acquisition unit to acquire characteristic information of the user.

The image processing apparatus includes a reception unit to receive, from the user, information indicating conversion processing to be performed on text included in the image data.

The image processing apparatus includes a conversion request transmission unit to transmit the image data, the characteristic information, and information indicating the conversion processing to an information processing apparatus through a network.

The image processing apparatus includes a conversion result reception unit to receive, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information.

The image processing apparatus includes an output unit to output the conversion result.

### Aspect 10

According to Aspect 10, an information processing apparatus connected to an image processing apparatus through a network includes a conversion request reception unit to receive image data that is read from a document by the image processing apparatus according to an instruction from a user, characteristic information of the user, and information indicating conversion processing to be performed on text included in the image data from the image processing apparatus.

The information processing system includes a character recognition unit to extract the text from the image data.

The information processing system includes a conversion unit to input information including an instruction instructing that the conversion processing is to be performed on the text and that a result of the conversion processing is to be suitable for a person corresponding to the characteristic information to a large language model and acquire a conversion result that is output by the large language model.

The information processing apparatus includes a conversion result transmission unit to transmit the conversion result to the image processing apparatus.

### Aspect 11

According to Aspect 11, an information processing method performed by a computer includes controlling reading of image data from a document according to an instruction from a user.

The information processing method includes acquiring characteristic information of the user.

The information processing method includes receiving, from the user, information indicating conversion processing to be performed on text included in the image data.

The information processing method includes transmitting the image data, the characteristic information, and information indicating the conversion processing to an information processing apparatus through a network.

The information processing method includes receiving, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information.

The information processing method includes outputting the conversion result.

### Aspect 12

According to Aspect 12, a program causes an information processing apparatus connected to an image processing apparatus through a network to perform a method.

The method includes receiving image data that is read from a document by the image processing apparatus according to an instruction from a user, characteristic information of the user, and information indicating conversion processing to be performed on text included in the image data from the image processing apparatus.

The method includes extracting the text from the image data.

The method includes inputting information including an instruction instructing that the conversion processing is to be performed on the text and that a result of the conversion processing is to be suitable for a person corresponding to the characteristic information to a large language model and acquiring a conversion result that is output by the large language model.

The method includes transmitting the conversion result to the image processing apparatus.

### Aspect 13

According to Aspect 13, a program causes a computer to perform a method. The method includes controlling reading of image data from a document according to an instruction from a user.

The method includes acquiring characteristic information of the user.

The method includes receiving, from the user, information indicating conversion processing to be performed on text included in the image data.

The method includes transmitting the image data, the characteristic information, and information indicating the conversion processing to an information processing apparatus through a network.

The method includes receiving, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information. The method includes outputting the conversion result.

### Aspect 14

According to Aspect 14, a program causes an information processing apparatus connected to an image processing apparatus through a network to perform a method.

The method includes receiving image data that is read from a document by the image processing apparatus according to an instruction from a user, characteristic information of the user, and information indicating conversion processing to be performed on text included in the image data from the image processing apparatus.

The method includes extracting the text from the image data.

The method includes inputting information including an instruction instructing that the conversion processing is to be performed on the text and that a result of the conversion processing is to be suitable for a person corresponding to the characteristic information to a large language model and acquiring a conversion result that is output by the large language model.

The method includes transmitting the conversion result to the image processing apparatus.

1. An information processing system, comprising circuitry configured to:
control reading of image data from a document according to an instruction from a user;
acquire characteristic information of the user;
receive, from the user, information indicating conversion processing to be performed on text included in the image data;
extract the text from the image data;
input, to a large language model, information including an instruction instructing that the conversion processing is to be performed on the text and that a result of the conversion processing is to be suitable for a person corresponding to the characteristic information;
acquire a conversion result that is output by the large language model; and
output the conversion result.

2. The information processing system according to claim 1, wherein the conversion processing is summarization of the text or translation of the text.

3. The information processing system according to claim 1, wherein the circuitry acquires setting information relating to a display language of the information processing system as a part of the characteristic information.

4. The information processing system according to claim 1, wherein the circuitry outputs, with the conversion result, information indicating a storage location where the image data or the text extracted from the image data is stored.

5. The information processing system according to claim 1, wherein the circuitry applies text styling to a word that appears more frequently than other words in text indicated by the conversion result.

6. The information processing system according to claim 1, wherein the characteristic information includes information indicating an organization to which the user belongs.

7. The information processing system according to claim 1, wherein the circuitry acquires a part of the characteristic information from image data including the user as a subject.

8. The information processing system according to claim 1, wherein the circuitry further receives an evaluation by the user for the conversion result.

9. An image processing apparatus, comprising circuitry configured to:
control reading of image data from a document according to an instruction from a user;
acquire characteristic information of the user;
receive, from the user, information indicating conversion processing to be performed on text included in the image data;
transmit the image data, the characteristic information, and information indicating the conversion processing to an information processing apparatus through a network;
receive, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information; and
output the conversion result.

10. The image processing apparatus according to claim 9, wherein the conversion processing is summarization of the text or translation of the text.

11. The image processing apparatus according to claim 9, wherein the circuitry acquires setting information relating to a display language of the image processing apparatus as a part of the characteristic information.

12. The image processing apparatus according to claim 9, wherein the circuitry outputs, with the conversion result, information indicating a storage location where the image data or the text extracted from the image data is stored.

13. The image processing apparatus according to claim 9, wherein the circuitry applies text styling to a word that appears relatively frequently in text indicated by the conversion result.

14. The image processing apparatus according to claim 9, wherein the characteristic information includes information indicating an organization to which the user belongs.

15. The image processing apparatus according to claim 9, wherein the circuitry acquires a part of the characteristic information from image data including the user as a subject.

16. The image processing apparatus according to claim 9, wherein the circuitry further receives an evaluation by the user for the conversion result.

17. An information processing method, comprising:
controlling reading of image data from a document according to an instruction from a user;
acquiring characteristic information of the user;
receiving, from the user, information indicating conversion processing to be performed on text included in the image data;
transmitting the image data, the characteristic information, and information indicating the conversion processing to an information processing apparatus through a network;
receiving, from the information processing apparatus, a conversion result obtained by a large language model to which information including an instruction is input, the instruction instructing that the conversion processing is to be performed on the text extracted from the image data and that a result of the conversion processing is to be suitable for a person corresponding to the characteristic information; and
outputting the conversion result.

18. A non-transitory recording medium storing a plurality of program codes which, when executed by one or more processors, causes the one or more processors to perform the method according to claim 17.
